(19) United States
(12) Patent Application Publication
(10) Pub. No.: US 2021/0055571 A1
(43) Pub. Date: Feb. 25, 2021

(54) EYEGLASSES

(71) Applicant: Kawamoto Optical Industrial Co., Ltd., Osaka (JP)

(72) Inventor: Shuichi KAWAMOTO, Osaka (JP)

(21) Appl. No.: 16/666,527

(22) Filed: Oct. 29, 2019

(30) Foreign Application Priority Data
Aug. 23, 2019 (JP) 2019-152762

(51) Int. Cl. G02C 5/12; G02C 1/02

(52) U.S. Cl. CPC G02C 5/12; G02C 1/02

(57) ABSTRACT

Provided are eyeglasses with a reduced total weight achieved by a reduction in the weight of nose pads. In the eyeglasses of the present invention, a through hole is provided in each nose pad, the through hole extending in the thickness direction of the nose pad. The through hole is preferably provided in a central portion of the nose pad, and is of a size such that, when the nose pad is viewed from the front, the through hole occupies a space that is about 10 to 80%, preferably 20 to 60%, and more preferably 30 to 50% of the nose pad. The nose pads are made of a rubber-like synthetic resin.

### BACKGROUND OF THE INVENTION

### 1. Field of the Invention

The present invention relates to eyeglasses, and particularly to eyeglasses having a reduced weight.

### 2. Description of Related Art

Lightweight eyeglasses reduce the stress on a nose portion, and cause less fatigue even when worn for a long period of time. Furthermore, lightweight eyeglasses are more likely to fit the body, and are also suitable for sporting situations.

Conventionally, the following methods have been adopted to achieve a reduction in the weight of eyeglasses.

(1) Lenses and frames are made thin, and lightweight materials are used (JP H7-199125A, JP 2013-88801A, etc.).

(2) Rimless lenses are employed (JP H7-28001A, etc.).

(3) Eyeglasses are designed to be worn on the nose (JP 2007-241203A, etc.).

JP H7-199125A, JP 2013-88801A, JP H7-28001A, and JP 2007-241203A are examples of related art.

### SUMMARY OF THE INVENTION

Methods such as those described above have been pursued to the utmost extent possible, and it is becoming increasingly difficult to achieve a further reduction in weight.

Thus, the inventor of the present invention contemplated reducing the total weight of eyeglasses by achieving a reduction in the weight of nose pads for a change. In particular, with respect to a pair of sunglasses made entirely of a synthetic resin, the inventor of the present invention aimed at reducing the total weight thereof to 10 g or less.

The present invention is directed to eyeglasses including a pair of lenses, a bridge that connects the pair of lenses, left and right nose pads that are located on a lower side of the bridge, and a pair of temples that are pivotable relative to the pair of lenses, wherein a through hole is provided in each nose pad, the through hole extending in a thickness direction of the nose pad. Here, the “through hole” refers to a through hole that contains nothing but air, in a finished pair of eyeglasses of the present invention.

The through hole is preferably provided in a central portion of the nose pad, and is of a size such that, when the nose pad is viewed from the front, the through hole occupies a space that is about 10 to 80%, preferably 20 to 60%, and more preferably 30 to 50% of the nose pad.

The nose pads are made of a rubber-like synthetic resin. Among other rubber-like synthetic resins, a polyester-based thermoplastic elastomer or a silicone rubber is preferable.

Preferably, in order to integrate the nose pads into the eyeglasses, a groove is provided in each nose pad, the groove being capable of accommodating a rod-shaped member extending from the bridge or a lens frame, but not passing through the nose pad.

As an alternative configuration, in order to integrate the nose pads into the eyeglasses, the bridge or the lens frame and the nose pads may also be integrally formed of a synthetic resin together with the rod-shaped members. In this case, the space occupied by each through hole is referred to with respect to only a nose pad portion excluding the rod-shaped member.

According to the present invention, a reduction in the weight of the eyeglasses is achieved by the through holes provided in the nose pads. In an embodiment, which will be described later, when the present invention is applied to a pair of sunglasses made entirely of a synthetic resin, the total weight thereof is reduced to 10 g or less. Moreover, when the eyeglasses are worn, the area of contact between a nose portion and each nose pad is small, and accordingly the stress on the nose portion is reduced.

### BRIEF DESCRIPTION OF THE DRAWINGS

Hereinafter, embodiments of the present invention will be described with reference to the accompanying drawings, taking a pair of sunglasses 1 as an example, in which:

FIG. 1 is a perspective view of a pair of sunglasses serving as an embodiment of the present invention;

FIG. 2 is a plan view of the pair of sunglasses;

FIG. 3 is a front view of the pair of sunglasses;

FIG. 4 is a rear view of the pair of sunglasses;

FIG. 5 is a side view of the pair of sunglasses;

FIG. 6 is a cross-sectional view taken along line 6-6 in FIG. 3, and

FIG. 7 illustrates a nose pad; where FIG. 7(a) is a front view, FIG. 7(b) is a side view, and FIG. 7(c) is a plan view.

### DETAILED DESCRIPTION OF PREFERRED EMBODIMENTS

### Embodiment 1

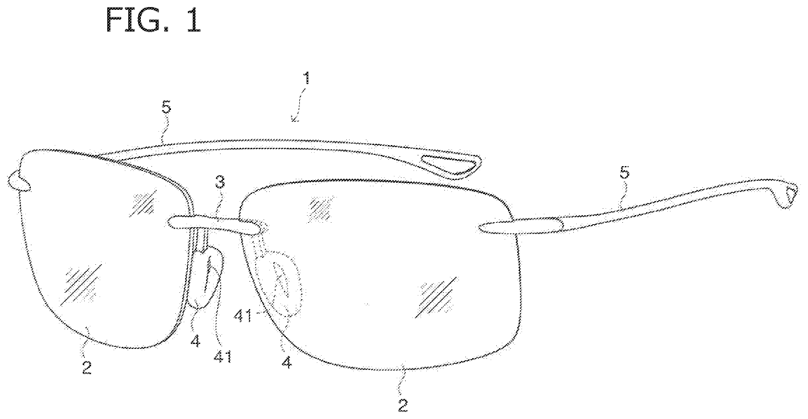

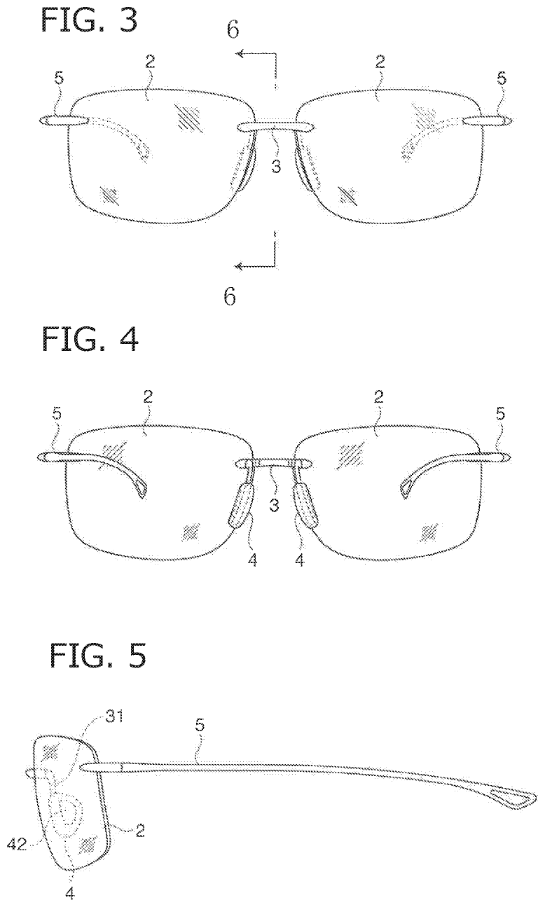

As shown in FIGS. 1 to 5, the pair of sunglasses 1 has, like conventional sunglasses, left and right lenses 2, a bridge 3 that connects the left and right lenses 2, left and right nose pads 4 suspended from and supported by the bridge 3, and left and right temples 5 that each include a coupling portion that can pivot on a hinge. The pair of eyeglasses of the prevent embodiment is made entirely of a synthetic resin in order to achieve a reduction in weight.

The bridge 3 and the coupling portions of the temples 5 are fixed to the lenses 2 in an inserted manner.

The structure of the nose pads 4 is a feature of the present invention.

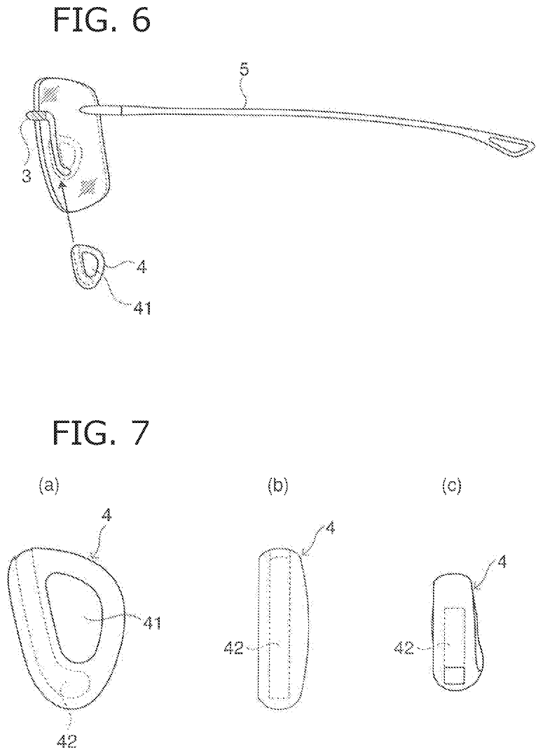

As shown in FIGS. 6 and 7, each nose pad 4 has a large through hole 41 in a central portion thereof in a front view, the through hole 41 extending in a thickness direction of the nose pad 4. In the embodiment shown in these drawings, the nose pad 4 is formed of a thin plate having an irregular elliptical shape, and the longest portion thereof in a longitudinal direction is about 1.5 cm long, the longest portion thereof in a lateral direction is about 1 cm long, and the thickest portion thereof in the thickness direction is about 0.4 cm thick. The longest portion of the through hole 41 in the longitudinal direction is about 0.8 cm long, the longest portion thereof in the lateral direction is about 0.5 cm long, and the thickest portion thereof is about 0.4 cm thick.

In this embodiment, when the nose pad 4 is viewed from the front (i.e., the state shown in FIG. 7(a)), the through hole 41 occupies a space that is about 40% of the nose pad 4. Depending on the material, the through hole 41 may occupy a space that is about 10 to 80%, preferably 20 to 60%, and more preferably 30 to 50% of the nose pad 4. If this space is 10% or less, the effect of reducing weight is small, and if the space is more than 80%, the strength of an edge portion is reduced.

The nose pads 4 are made of a rubber-like synthetic resin. Among other rubber-like synthetic resins, a polyester-based thermoplastic elastomer is preferable, and, for example, “TEFABLOC” (trademark of MCPP France SAS) can be used.

To fix the nose pads 4 to the bridge 3, two rod-shaped members 31 are suspended from the bridge 3 as shown in FIG. 6. For eyeglasses of a type in which the lenses are supported by a lens frame (not shown), the rod-shaped members may extend from the lens frame. Terminal ends of the rod-shaped members 31 are slightly curved. On the other hand, as shown in FIG. 7, grooves 42 for receiving the rod-shaped members 31 are provided in the respective nose pads 4, the grooves 42 not passing through the nose pads 4. Terminal ends of the grooves 42 are also slightly curved to conform with the terminal ends of the rod-shaped members 31.

In order to integrate each nose pad 4 with a corresponding one of the rod-shaped members 31, it is sufficient to merely insert the rod-shaped member 31 into the groove 42 of the nose pad 4. The terminal ends of the rod-shaped members 31 and the grooves 42 are slightly curved for the purpose of preventing the rod-shaped members 31 from easily coming out.

The method for fixing the nose pads 4 to the bridge 3 or the lens frame is not limited to the above-described method, and a fixing member, such as a clamping member, may be used, or an adhesive may be used.

### Embodiment 2

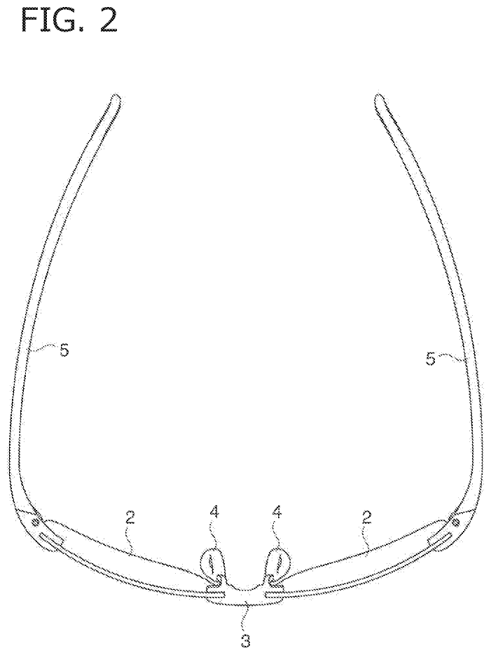

Although not shown in the drawings because the finished shape is almost the same as that of Embodiment 1 shown in FIGS. 1 and 2, the bridge 3, the rod-shaped members 31, and the nose pads 4 may also be integrally formed of a synthetic resin. The configuration of the through holes 41 in the nose pad 4 portions is similar to that of Embodiment 1.

However, since the nose pads 4 are integrally formed with the bridge 3 and the rod-shaped members 31, the grooves 42 are no longer necessary. Moreover, in Embodiment 2, priority is given to the strength of the bridge 3, and therefore it is envisaged that a hard synthetic resin will be used more often for the nose pads 4 than in the case of Embodiment 1.

### LIST OF REFERENCE NUMERALS

1 Sunglasses
2 Lens
3 Bridge
31 Rod-shaped member
4 Nose pad
41 Through hole
42 Groove

What is claimed is:

1. Eyeglasses comprising:
a pair of lenses (2);
a bridge (3) that connects the pair of lenses (2);
a pair of nose pads (4) that are located on a lower side of the bridge (3); and
a pair of temples (5) that are pivotable relative to the pair of lenses (2),
wherein a through hole (41) is provided in each nose pad (4), the through hole (41) containing nothing but air, and extending in a thickness direction of the nose pad (4).

2. The eyeglasses according to claim 1,
wherein the through hole (41) is provided in a central portion of the nose pad (4), and is of a size such that, when the nose pad (4) is viewed from the front, the through hole (41) occupies a space that is 10 to 80% of the nose pad (4).

3. The eyeglasses according to claim 2,
wherein, when the nose pad (4) is viewed from the front, the space occupied by the through hole (41) is 20 to 60% of the nose pad (4).

4. The eyeglasses according to claim 1,
wherein, when the nose pad (4) is viewed from the front, the space occupied by the through hole (41) is 30 to 50% of the nose pad (4).

5. The eyeglasses according to claim 1,
wherein the nose pads (4) are made of a rubber-like synthetic resin.

6. The eyeglasses according to claim 1,
wherein a groove (42) is provided extending in each nose pad (4), but not passing therethrough.

7. The eyeglasses according to claim 1,
wherein the bridge (3) and the nose pads (4) are integrally formed of a synthetic resin.
